(19) United States
(12) Patent Application Publication
(10) Pub. No.: US 2017/0160307 A1
(43) Pub. Date: Jun. 8, 2017

(54) SENSOR

(71) Applicant: Panasonic Intellectual Property Management Co., Ltd., Osaka (JP)

(72) Inventors: KIYOHIKO TAKAGI, Osaka (JP); RITSU NAKAYOSHI, Fukui (JP); YOUHEI SHIMADA, Fukui (JP); MASANORI YAMAUCHI, Fukui (JP); TAKASHI IMANAKA, Osaka (JP)

(21) Appl. No.: 15/320,372

(22) PCT Filed: Jul. 3, 2015
(86) PCT No.: PCT/JP2015/003355

§ 371 Date: Dec. 20, 2016

(30) Foreign Application Priority Data
Jul. 4, 2014 (JP) 2014-138802

(51) Int. Cl. G01P 15/08

(52) U.S. Cl. CPC G01P 15/08; G01P 2015/0871; G01P 2015/0874

(57) ABSTRACT

A sensor includes a first substrate, a first protruding portion provided on an upper surface of the first substrate, a support portion provided on the upper surface of the first substrate, a beam portion supported at a first end of the beam portion by the support portion, and a weight portion provided to a second end of the beam portion. The upper surface of the first protruding portion has a first surface and a second surface. The second surface is located above the first surface with the upper surface of the first substrate as a reference.

### TECHNICAL FIELD

The present disclosure relates to a sensor used for a vehicle, a navigation system, or a mobile terminal, such as an inertial sensor which is, for example, an acceleration sensor or an angular velocity sensor, a strain sensor, or a barometric pressure sensor.

### BACKGROUND ART

A conventional sensor will be described below with reference to the drawings. FIG. 16 is a sectional view of a conventional sensor that is an acceleration sensor.

In FIG. 16, sensor 1 includes substrate 2, support portion 3 provided on the upper surface of substrate 2, weight portion 4 facing the upper surface of substrate 2, beam portion 5 connected to support portion 3 and weight portion 4, and protruding portion 6 formed on the lower surface of weight portion 4. One end of beam portion 5 is connected to support portion 3, and the other end is connected to weight portion 4.

The operation of the conventional sensor thus configured will be described.

FIGS. 17 and 18 are schematic sectional views of sensor 1 illustrated in FIG. 16 as viewed from direction 1A.

In FIG. 17, acceleration is not applied to sensor 1. In FIG. 18, excessive impact is applied to sensor 1 in the negative direction of an X axis. When excessive impact is applied in the X axis direction, weight portion 4 rotates around the Y axis, as illustrated in FIG. 18. Ridge line 7 of weight portion 4 (corner of weight portion 4) and substrate 2 are brought into contact with each other, which prevents weight portion 4 from rotating further. According to this configuration, plastic deformation of beam portion 5 can be prevented. Therefore, an output signal from sensor 1 is stabilized.

### CITATION LIST

### Patent Literature

PTL 1: Unexamined Japanese Patent Publication No. 2007-132863

However, in conventional sensor 1 described above, since only ridge line 7 of weight portion 4 comes into contact with substrate 2, stress is concentrated on a corner (ridge line 7) of weight portion 4. Thus, weight portion 4 and substrate 2 are liable to adhere to each other due to sticking.

### SUMMARY OF THE INVENTION

An object of the present disclosure is to provide a sensor that has enhanced reliability by preventing a weight portion and a substrate from adhering to each other due to sticking, even when excessive acceleration is applied.

The present disclosure includes the following configuration to attain the object.

A sensor includes a first substrate, a first protruding portion provided on an upper surface of the first substrate, a support portion provided on the upper surface of the first substrate, a beam portion supported at a first end of the beam portion by the support portion, and a weight portion provided to a second end of the beam portion. The upper surface of the first protruding portion has a first surface and a second surface. The second surface is located above the first surface with the upper surface of the first substrate as a reference.

According to this configuration, when the weight portion is maximally moved, the first protruding portion and the weight portion come into contact with each other on at least two locations (at least two different lines).

Accordingly, this configuration can prevent concentration of stress on only the ridge line of the weight portion, thus being capable of preventing the weight portion and the first protruding portion from sticking each other.

### BRIEF DESCRIPTION OF DRAWINGS

FIG. 1 is a top view of a sensor according to a first exemplary embodiment.

FIG. 2 is a sectional view of the sensor along line 1B-1B according to the first exemplary embodiment.

FIG. 3 is a circuit diagram of the sensor according to the first exemplary embodiment.

FIG. 4A is a sectional view for describing an operation of the sensor according to the first exemplary embodiment.

FIG. 4B is a schematic view for describing the operation of the sensor according to the first exemplary embodiment.

FIG. 5 is a sectional view of a sensor according to a modification of the first exemplary embodiment.

FIG. 6 is a partially enlarged view of the sectional view of the sensor according to the modification of the first exemplary embodiment.

FIG. 7 is a sectional view of a sensor according to a second exemplary embodiment.

FIG. 8 is a sectional view of the sensor along line 5B-5B according to the second exemplary embodiment.

FIG. 9 is a top view of a sensor according to a third exemplary embodiment.

FIG. 10 is a sectional view of the sensor along line 6B-6B according to the third exemplary embodiment.

FIG. 11 is a sectional view for describing an operation of the sensor according to the third exemplary embodiment.

FIG. 12 is a sectional view for describing an operation of the sensor according to the third exemplary embodiment.

FIG. 13 is a top view of a sensor according to a modification of the third exemplary embodiment.

FIG. 14 is a sectional view of the sensor along line 8B-8B according to the modification of the third exemplary embodiment.

FIG. 15A is a top view of a sensor according to a fourth exemplary embodiment.

FIG. 15B is a schematic view for describing the operation of the sensor according to the fourth exemplary embodiment.

FIG. 16 is a sectional view of a conventional sensor.

FIG. 17 is a schematic sectional view of the conventional sensor.

FIG. 18 is a schematic sectional view of the conventional sensor.

### DESCRIPTION OF EMBODIMENTS

### First Exemplary Embodiment

A sensor according to a first exemplary embodiment will be described below with reference to the drawings.

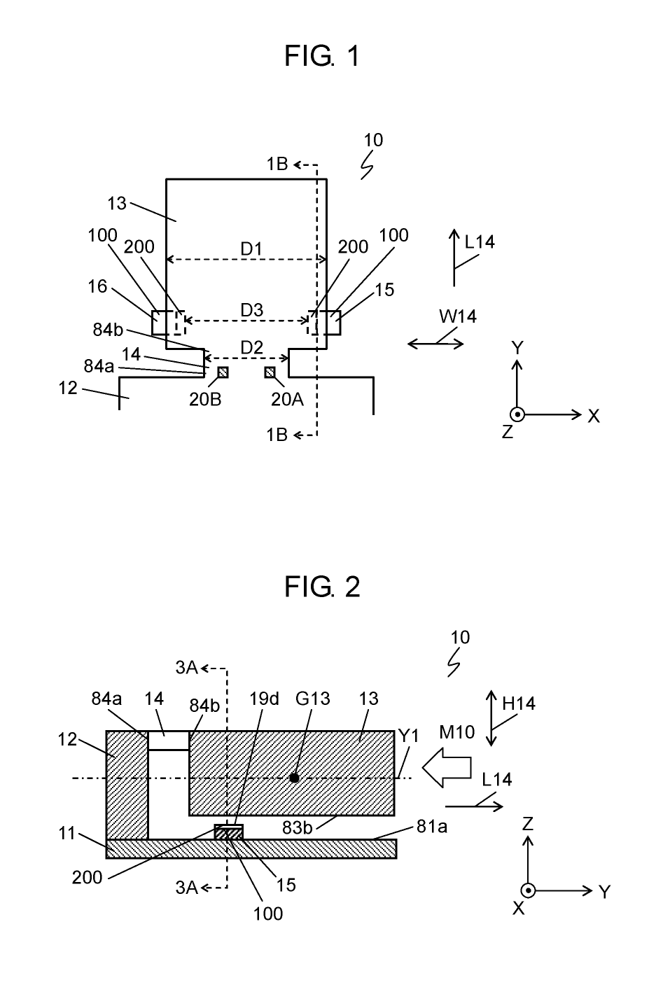

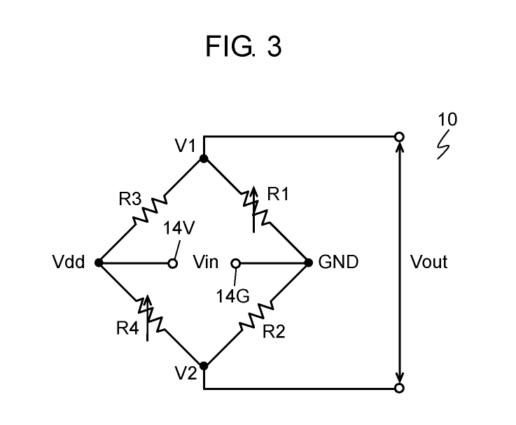

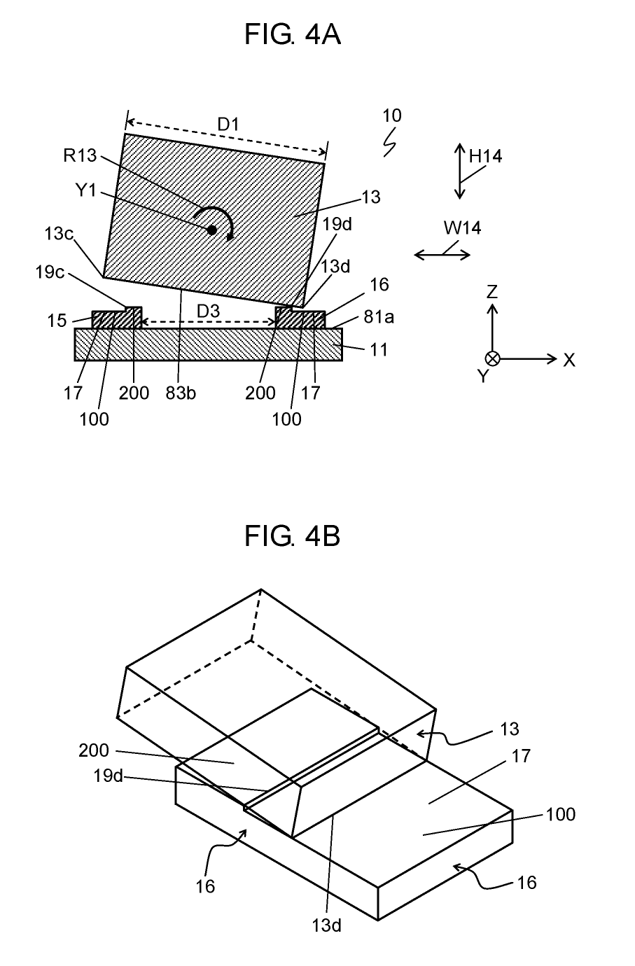

FIG. 1 is a top view of sensor 10 according to the first exemplary embodiment, FIG. 2 is a sectional view of sensor 10 illustrated in FIG. 1 along line 1B-1B, FIG. 3 is a circuit diagram of the sensor according to the first exemplary embodiment, and FIG. 4A is a sectional view of sensor 10 illustrated in FIG. 2 along line 3A-3A. For the sake of convenience, FIG. 4A illustrates the state after sensor 10 receives impact in an X direction for facilitating the description below.

In FIGS. 1, 2, and 4A, sensor 10 includes first substrate 11, support portion 12 connected to upper surface 81a of first substrate 11, weight portion 13 having lower surface 83b facing upper surface 81a of first substrate 11, beam portion 14 connecting support portion 12 and weight portion 13, and lower protruding portions 15 and 16 provided on upper surface 81a of first substrate 11. Lower protruding portions 15 and 16, which have an overall height (height from upper surface 81a of first substrate 11 to second surface 200) is about 3 μm, are provided with stepped parts 17 (difference between second surface 200 and first surface 100) with a height of 270 nm. Therefore, the height of stepped parts 17 with respect to the overall height of lower protruding portions 15 and 16 is about 9%. Lower protruding portions 15 and 16 are formed with ridge lines 19c and 19d due to stepped parts 17. Stepped parts 17 are formed on lower protruding portions 15 and 16 such that the heights of lower protruding portions 15 and 16 are increased in the direction of rotation axis Y1 of the weight portion 13.

Beam portion 14 has one end 84a (first end) connected to support portion 12 and other end 84b (second end) opposite to one end 84a, and extends from one end 84a to other end 84b in extension direction L14. Weight portion 13 is connected to other end 84b of beam portion 14. Width D1 of weight portion 13 in width direction W14 which is perpendicular to extension direction L14 and parallel to upper surface 81a of first substrate 11 is larger than width D2 of beam portion 14 in width direction W14. Space D3 between lower protruding portion 15 and lower protruding portion 16 in width direction W14 is larger than width D2 of beam portion 14 and smaller than width D1 of weight portion 13. Space D3 is a distance between planes facing each other of lower protruding portions 15 and 16.

The Y axis parallel to extension direction L14, the X axis parallel to width direction W14, and the Z axis which is height direction H14 perpendicular to extension direction L14 (X axis) and width direction W14 (Y axis) are defined. In the first exemplary embodiment, sensor 10 is an acceleration sensor that detects acceleration in the Z axis direction. In sensor 10, when impact in the X axis direction perpendicular to the Z axis is generated, the rotation of weight portion 13 around the Y axis is restricted by lower protruding portions 15 and 16, and this can prevent beam portion 14 from being broken.

[Detail of Configuration of Sensor 10]

The configuration of sensor 10 will be described below in detail.

First substrate 11, support portion 12, weight portion 13, beam portion 14, and lower protruding portions 15 and 16 are formed from a material such as silicon, fused quartz, or alumina. Silicon is preferably used, and use of silicon implements compact sensor 10 using a microfabrication technology.

First substrate 11 and support portion 12 can be connected to each other with any one of methods of bonding using an adhesive material, metal bonding, ambient temperature bonding, and anodic bonding. An adhesive such as epoxy resin or silicone resin is used as the adhesive material. When the silicone resin is used as the adhesive material, stress applied to first substrate 11 and support portion 12 can be decreased accompanied with curing of the adhesive material itself.

The thickness of beam portion 14 in height direction H14 is smaller than the thickness of weight portion 13. With this configuration, when acceleration is externally applied and weight portion 13 is displaced by this acceleration, distortion is generated on beam portion 14, and the acceleration can be detected by detecting this distortion.

Detectors 20A and 20B for detecting acceleration are provided to beam portion 14. Detectors 20A and 20B can employ a detection method such as a strain resistance method or a capacitance method. When piezo resistance is used for the strain resistance method, the sensitivity of sensor 10 can be enhanced. When a thin-film resistance method using an oxide film strain resistor is used as the strain resistance method, the temperature characteristics of sensor 10 can be enhanced.

[Circuit Configuration of Sensor 10]

Next, the circuit configuration of sensor 10 will be described with reference to FIG. 3. FIG. 3 is a circuit diagram of the sensor according to the first exemplary embodiment.

FIG. 3 is a circuit diagram of sensor 10 which uses the strain resistance method for detectors 20A and 20B. Detector 20A has resistor R1, and detector 20B has resistor R4. Resistors R2 and R3 are provided on support portion 12. Resistors R1, R2, R3, and R4 are connected to connection points Vdd, GND, V1, and V2 in a bridge shape to configure a bridge circuit. A voltage is applied between a pair of connection points Vdd and GND, which face each other, and potential difference Vout between the other pair of connection points V1 and V2 is detected, so that acceleration applied to sensor 10 can be detected.

[Operation of Sensor 10 when Sensor 10 Receives Impact in X Direction]

Next, the state in which sensor 10 receives impact in the X direction will be described with reference to FIGS. 4A and 4B.

FIG. 4A is a sectional view of sensor 10 illustrated in FIG. 2 along line 3A-3A as viewed from direction M10 in FIG. 2. FIG. 4B is a schematic view for describing the operation of the sensor. FIG. 4B is a view illustrating the state after the sensor receives impact in the X direction as viewed diagonally. Note that, for easy understanding of the state of sensor 10, lower protruding portion 16 and weight portion 13 are only partially illustrated in FIG. 4B.

Weight portion 13 has ridge lines 13c and 13d. When weight portion 13 rotates around axis Y1, ridge lines 13c and 13d come into contact with the top of lower protruding portions 15 and 16. That is, ridge lines 13c and 13d correspond to the corners on the lower surface of the weight portion.

On the other hand, lower protruding portions 15 and 16 have ridge lines 19c and 19d. When weight portion 13 rotates around axis Y1, ridge lines 19c and 19d are brought into contact with lower surface 83b of weight portion 13. That is, ridge lines 19c and 19d correspond to ends of lower protruding portions 15 and 16 on second surfaces 200 on the side of first surfaces 100.

Next, the operation of sensor 10 when impact is applied in the positive direction of the X axis and excessive acceleration is applied will be described with reference to FIGS. 4A and 4B.

In the case where excessive acceleration is applied due to the impact in the positive direction in the X axis, weight portion 13 rotates in direction R13, in which lower surface 83b of weight portion 13 approaches lower protruding portion 16 and moves away from lower protruding portion 15, around axis Y1 which is parallel to the Y axis and passes through center of gravity G13 of weight portion 13. With this, beam portion 14 is distorted. Here, stepped parts 17 are formed on lower protruding portions 15 and 16 on first substrate 11. That is, the height difference between first surface 100 and second surface 200 is formed. Due to stepped parts 17, lower protruding portions 15 and 16 are configured to be higher toward rotation axis Y1 of weight portion 13. That is, second surface 200 is located above first surface 100 with the upper surface of first substrate 11 as a reference. When weight portion 13 rotates around axis Y1 in direction R13, ridge line 13d of weight portion 13 comes into contact with first surface 100 of lower protruding portion 16, by which the rotation of weight portion 13 in direction R13 is restricted. Simultaneously, ridge line 19d (the end of second surface 200) formed on the upper surface of lower protruding portion 16 is brought into contact with lower surface 83b of weight portion 13.

Specifically, in sensor 10 according to the first exemplary embodiment, lower protruding portion 16 on first substrate 11 and weight portion 13 are in contact with each other on two different locations which are on ridge line 13d and ridge line 19d, and this can prevent concentration of stress on only ridge line 13d of the weight portion. Accordingly, this configuration can prevent weight portion 13 and lower protruding portion 16 on first substrate 11 from sticking each other.

In addition, it is configured such that stepped part 17 is formed on lower protruding portion 16 on first substrate 11, and when weight portion 13 is maximally moved, ridge line 19d of lower protruding portion 16 is brought into contact with the lower surface of weight portion 13 and lower ridge line 13d of weight portion 13 comes into contact with stepped part 17 (first surface 100) of lower protruding portion 16. In the present exemplary embodiment, as stepped part 17 is only formed on lower protruding portion 16, ridge line 19d of lower protruding portion 16 which is brought into contact with lower surface 83b of weight portion 13 can easily be formed.

Next, a case where weight portion 13 rotates in the direction opposite to direction R13 will be described with reference to FIG. 4A. Note that the state in which weight portion 13 rotates in the direction opposite to direction R13 is not illustrated.

When weight portion 13 rotates in the direction opposite to direction R13, ridge line 13c of weight portion 13 comes into contact with stepped part 17 (first surface 100) of lower protruding portion 15, by which the rotation of weight portion 13 is restricted. Simultaneously, ridge line 19c formed on the upper surface of lower protruding portion 15 is brought into contact with lower surface 83b of weight portion 13. Space D3 between lower protruding portion 15 and lower protruding portion 16 in width direction W14 is larger than width D2 (illustrated in FIG. 1) of beam portion 14 in width direction W14 and smaller than width D1 of weight portion 13 in width direction W14. Space D3 is a distance between planes facing each other of lower protruding portions 15 and 16. Thus, stress on beam portion 14 due to the rotation of weight portion 13 can effectively be reduced.

Notably, sensor 10 according to the first exemplary embodiment is configured such that stepped parts 17 are formed on lower protruding portions 15 and 16 on first substrate 11, and when weight portion 13 is maximally moved, ridge line 19d of lower protruding portions 15 and 16 is brought into contact with lower surface 83b of weight portion 13 and lower ridge lines 13c and 13d of weight portion 13 come into contact with stepped parts 17 (first surfaces 100) of lower protruding portions 15 and 16.

Specifically, sensor 10 according to the present exemplary embodiment includes first substrate 11, first protruding portion (lower protruding portions 15 and 16) provided on upper surface 81a of first substrate 11, support portion 12 provided on upper surface 81a of first substrate 11, beam portion 14 supported at a first end (one end 84a) of beam portion 14 by support portion 12, and weight portion 13 provided to second end (other end 84b) of beam portion 14. The upper surface of the first protruding portion (lower protruding portions 15 and 16) has first surface 100 and second surface 200. Further, second surface 200 is located above first surface 100 with the upper surface of first substrate 11 as a reference.

When weight portion 13 is rotated, weight portion 13 comes into line contact with first surface 100 and comes into line contact with the end of second surface 200.

In addition, more preferably, in sensor 10 according to the present exemplary embodiment, first surface 100 is located to extend from a region outside of a peripheral edge of weight portion 13 to a region inside of the peripheral edge of weight portion 13 in a planar view, and second surface 200 is located in a region inside of the peripheral edge of weight portion 13 in a planar view.

### Modification of First Exemplary Embodiment

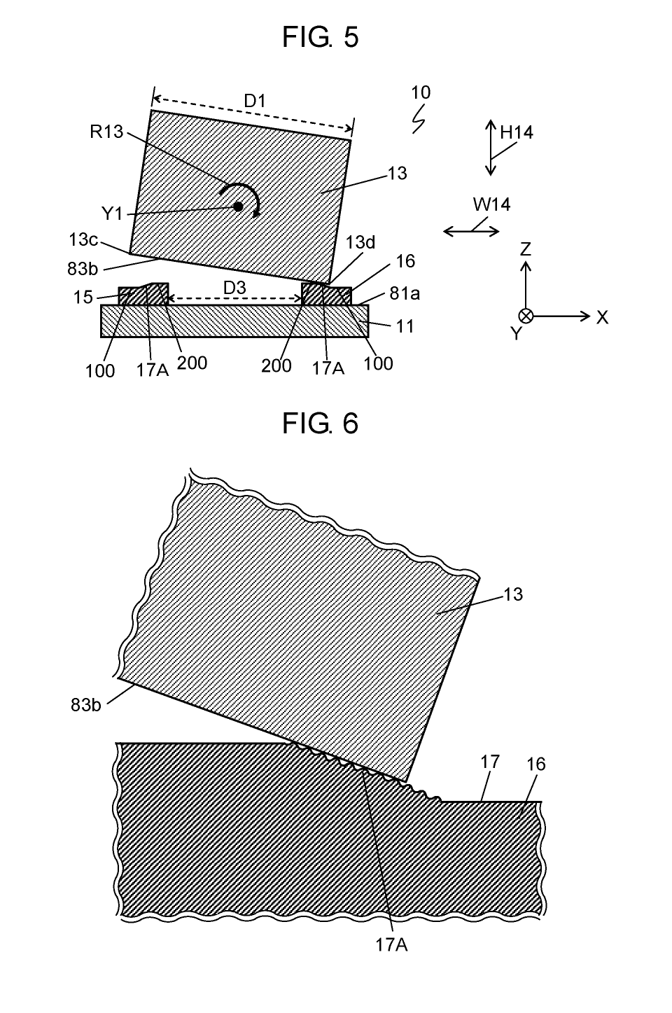

Next, a sensor according to a modification of the first exemplary embodiment will be described with reference to FIGS. 5 and 6. FIG. 5 is a sectional view of the sensor according to the modification of the first exemplary embodiment. FIG. 6 is a partially enlarged view of the sectional view of the sensor according to the modification of the first exemplary embodiment. Note that the components same as those in the first exemplary embodiment are denoted by the same reference marks, and the description thereof will be omitted.

As illustrated in FIG. 5, stepped parts 17 (height difference between first surface 100 and second surface 200) having taper surfaces 17A are formed on lower protruding portions 15 and 16 on first substrate 11. Due to stepped parts 17, lower protruding portions 15 and 16 are configured to be higher toward rotation axis Y1 of the weight portion.

That is, first surface 100 and second surface 200 are connected to each other with the taper surface.

According to the modification of the first exemplary embodiment, a contact area between weight portion 13 and lower protruding portions 15 and 16 is significantly increased due to taper surfaces 17A formed on lower protruding portions 15 and 16. Therefore, stress generated on the contact surface between weight portion 13 and lower protruding portions 15 and 16 is significantly reduced. This configuration can more reliably prevent weight portion 13 and lower protruding portions 15 and 16 on first substrate 11 from sticking each other.

In addition, as illustrated in FIG. 6, a plurality of irregularities having arithmetic mean roughness Ra of from 1 nm to 150 nm inclusive is formed on taper surface 17A of lower protruding portion 16 on first substrate 11, by which the lower surface of weight portion 13 and taper surface 17A are in contact with each other on multiple points. That is, taper surface 17A has a plurality of irregularities.

This configuration can prevent planar bonding between taper surface 17A and lower surface 83b of weight portion 13. If a plurality of irregularities is formed on taper surface 17A of lower protruding portion 15 as in lower protruding portion 16, the similar effect can be obtained.

### Second Exemplary Embodiment

A sensor according to a second exemplary embodiment will be described below with reference to the drawings.

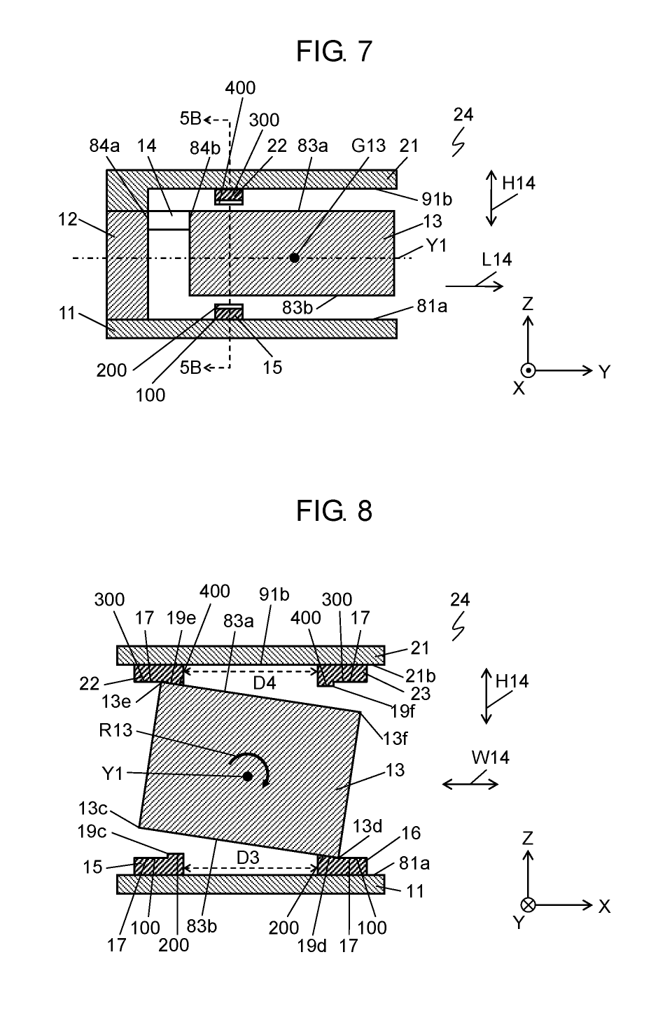

FIG. 7 is a sectional view of sensor 24 according to the second exemplary embodiment, and FIG. 8 is a sectional view of sensor 24 illustrated in FIG. 7 along line 5B-5B. Note that, in FIGS. 7 and 8, the components same as those in the first exemplary embodiment are denoted by the same reference marks, and the description thereof will be omitted.

As illustrated in FIG. 7, sensor 24 according to the second exemplary embodiment further includes second substrate 21 connected to support portion 12 and upper protruding portions 22 and 23 (second protruding portions) formed on second substrate 21, in addition to the configuration of sensor 10 (see FIG. 2) according to the first exemplary embodiment. Second substrate 21 is fixed to support portion 12 so as to be immovable with respect to first substrate 11. Second substrate 21 includes lower surface 91b facing upper surface 83a of weight portion 13. Weight portion 13 is provided between upper surface 81a of first substrate 11 and lower surface 91b of second substrate 21. Upper protruding portions 22 and 23 are formed on lower surface 91b of second substrate 21. Upper protruding portions 22 and 23 are formed on positions symmetric with lower protruding portions 15 and 16 formed on upper surface 81a of first substrate 11 with respect to weight portion 13. Specifically, space D4 between upper protruding portion 22 and upper protruding portion 23 in width direction W14 is equal to space D3 between lower protruding portion 15 and lower protruding portion 16 in width direction W14. Space D4 is a distance between planes facing each other of upper protruding portions 22 and 23. Space D4 between upper protruding portions 22 and 23 is larger than width D2 of beam portion 14 in width direction W14 and smaller than width D1 of weight portion 13 in width direction W14 (see FIG. 1). Weight portion 13 has ridge lines 13e and 13f located below upper protruding portions 22 and 23. According to this configuration, ridge lines 13c and 13d of lower surface 83b of weight portion 13 come into contact with stepped parts 17 (first surfaces 100) of lower protruding portions 15 and 16 respectively, and ridge lines 13e and 13f of upper surface 83a of weight portion 13 come into contact with stepped parts 17 (third surfaces 300) of upper protruding portions 22 and 23 respectively. Simultaneously, upper surface 83a of weight portion 13 comes into contact with ridge lines 19e and 19f (ends of fourth surfaces 400) of upper protruding portions 22 and 23, and lower surface 83b of weight portion 13 comes into contact with ridge lines 19c and 19d (ends of second surfaces 200) of lower protruding portions 15 and 16 on first substrate 11. Accordingly, the rotation of weight portion 13 can more reliably be suppressed, and thus the distortion of beam portion 14 can be suppressed.

Specifically, the sensor according to the second exemplary embodiment is configured such that, when weight portion 13 is maximally moved, ridge line 19e of upper protruding portion 22 is brought into contact with upper surface 83a of weight portion 13 and upper ridge line 13e of weight portion 13 comes into contact with stepped part 17 (third surface 300) of upper protruding portion 22.

That is, the sensor according to the third exemplary embodiment further includes second substrate 21 provided to an upper part of support portion 12 and extending from support portion 12, and upper protruding portion 22 or 23 (second protruding portion) provided on lower surface 91b of second substrate 21. First substrate 11 and second substrate 21 are disposed to be parallel to each other. The lower surface of upper protruding portion 22 or 23 (second protruding portion) has third surface 300 and fourth surface 400. Fourth surface 400 is located below third surface 300 with lower surface 91b of second substrate 21 as a reference.

When weight portion 13 is rotated, weight portion 13 comes into line contact with third surface 300 and comes into line contact with the end of fourth surface 400.

More preferably, third surface 300 is located to extend from a region outside of a peripheral edge of weight portion 13 to a region inside of the peripheral edge of weight portion 13 in a planar view. Fourth surface 400 is located in a region inside of the peripheral edge of weight portion 13 in a planar view.

According to this configuration, ridge line 19e of upper protruding portion 22 that is to be brought into contact with the upper surface of weight portion 13 can easily be formed only by forming stepped part 17 (height difference between third surface 300 and fourth surface 400) on upper protruding portion 22. It is to be noted that upper protruding portion 23 having the similar configuration to that of upper protruding portion 22 also provides the similar effect.

### Third Exemplary Embodiment

Next, a sensor according to a third exemplary embodiment will be described with reference to the drawings.

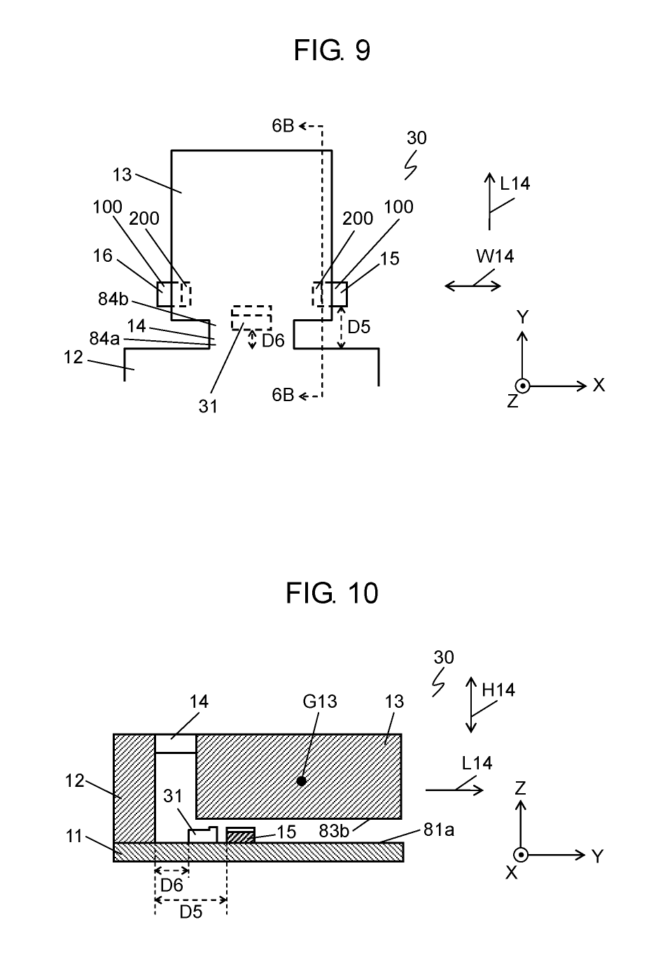

FIG. 9 is a top view of sensor 30 according to the third exemplary embodiment, and FIG. 10 is a sectional view of sensor 30 illustrated in FIG. 9 along line 6B-6B. Note that, in FIGS. 9 and 10, the components same as those in the first exemplary embodiment are denoted by the same reference marks, and the description thereof will be omitted.

As illustrated in FIG. 9, sensor 30 has the configuration in which lower protruding portion 31 is additionally provided to sensor 10 according to the first exemplary embodiment. Lower protruding portion 31 is formed on upper surface 81a of first substrate 11. Lower protruding portion 31 is located between lower protruding portion 15 and lower protruding portion 16 in width direction W14. Lower protruding portion 31 can suppress excessive displacement of weight portion 13 in the Z axis direction.

When impact is applied to sensor 30, weight portion 13 rotates around center of gravity G13 due to the contact with lower protruding portion 15 or 16. Distance D5 between support portion 12 and each of lower protruding portions 15 and 16 in extension direction L14 is larger than distance D6 between lower protruding portion 31 and support portion 12 in extension direction L14. Lower protruding portions 15 and 16 are located closer to center of gravity G13 of weight portion 13 compared to the position of lower protruding portion 31. This configuration can prevent thin beam portion 14 from being broken due to the rotation of weight portion 13 around center of gravity G13. Notably, when lower protruding portions 15 and 16 are located beyond center of gravity G13 in extension direction L14, the range of movement of weight portion 13 in the Z axis direction is decreased. Therefore, it is preferable that lower protruding portions 15 and 16 are provided between center of gravity G13 and support portion 12.

The formation of lower protruding portion 31 between each of lower protruding portions 15 and 16 and the support portion can more reliably suppress excessive displacement of weight portion 13 in the Z axis direction.

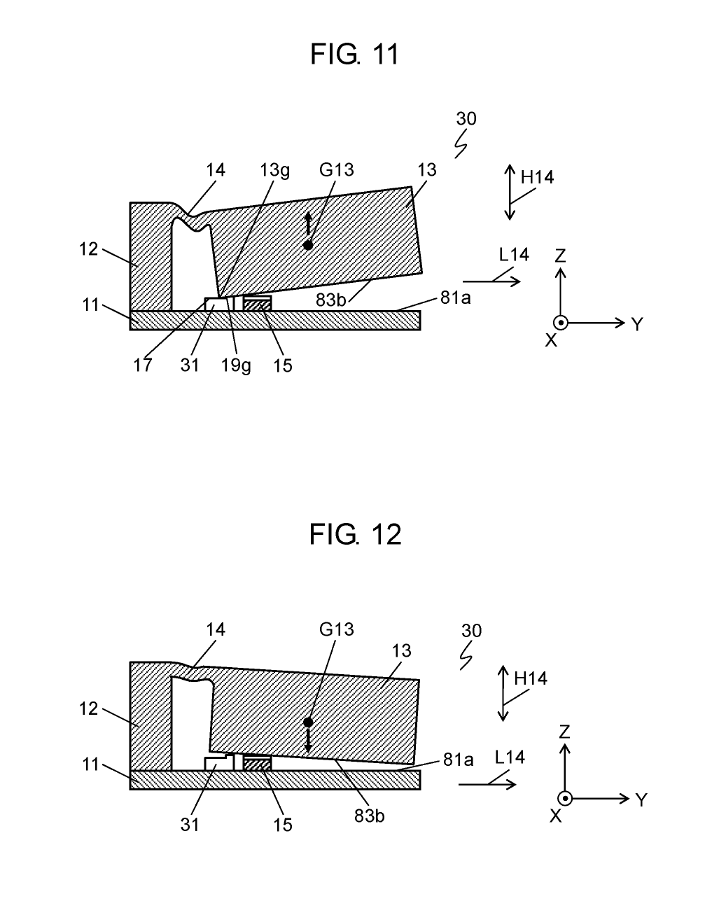

FIGS. 11 and 12 are sectional views of sensor 30 in which weight portion 13 is displaced in the Z axis direction due to excessive impact applied to sensor 30 in the Z axis direction. In FIG. 11, excessive impact is applied to sensor 30 in the positive direction in the Z axis, that is, from below. Although lower protruding portion 16 is not illustrated in FIGS. 11 and 12, it has the similar configuration to that of lower protruding portion 15.

In FIGS. 11 and 12, lower protruding portion 31 is provided closer to support portion 12 for weight portion 13 compared to the position of lower protruding portion 15 (16). Thus, ridge line 13g of weight portion 13 comes into contact with stepped part 17 of lower protruding portion 31, so that the rotation of weight portion 13 is restricted. Simultaneously, ridge line 19g formed on the upper surface of lower protruding portion 31 is brought into contact with lower surface 83b of weight portion 13, which can effectively prevent weight portion 13 from being excessively displaced in the positive direction in the Z axis. In FIG. 12, excessive impact is applied to sensor 30 in the negative direction in the Z axis, that is, from above. In this case, since lower protruding portion 15 (16) is provided closer to center of gravity G13 compared to the position of lower protruding portion 31, lower surface 83b of weight portion 13 comes into contact with lower protruding portion 15 (16), which can effectively prevent weight portion 13 from being excessively displaced in the negative direction in the Z axis.

### Modification of Third Exemplary Embodiment

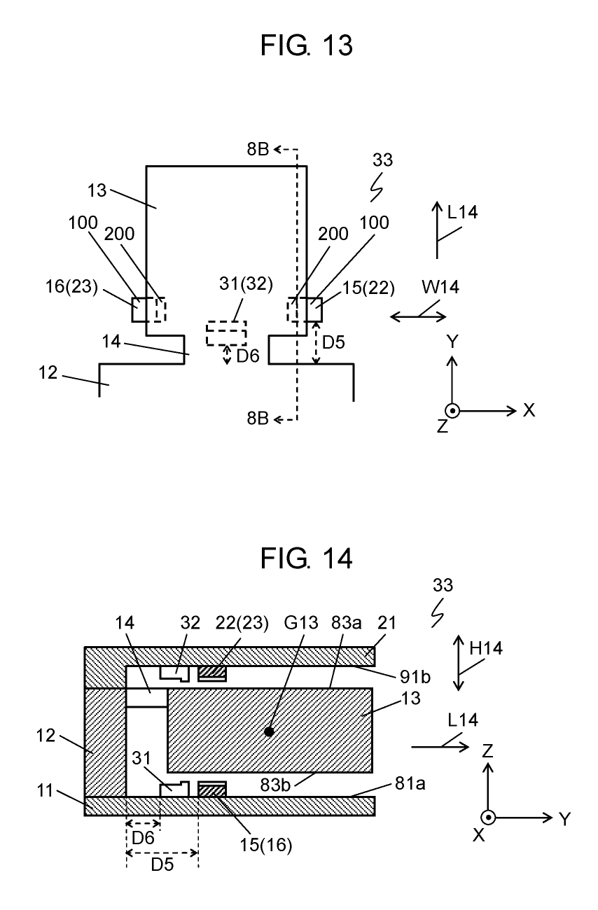

Next, a sensor according to a modification of the third exemplary embodiment will be described with reference to FIGS. 13 and 14. FIG. 13 is a top view of sensor 33 according to the modification of the first exemplary embodiment. Note that FIG. 13 does not illustrate first substrate 11 and second substrate 21. FIG. 14 is a sectional view of sensor 33 illustrated in FIG. 13 along line 8B-8B.

In FIGS. 13 and 14, the components same as those in the other exemplary embodiments are denoted by the same reference marks, and the description thereof will be omitted.

In sensor 33 illustrated in FIGS. 13 and 14, second substrate 21 is connected to support portion 12, and upper protruding portions 22 and 23 as well as upper protruding portion 32 located between upper protruding portions 22 and 23 in width direction W14 are provided on lower surface 91b of second substrate 21 facing weight portion 13. Upper protruding portions 22, 23, and 32 provided on lower surface 91b of second substrate 21 are formed on positions symmetric with lower protruding portions 15, 16, and 31 formed on upper surface 81a of first substrate 11 with respect to weight portion 13. According to this configuration in which lower protruding portion 31 and upper protruding portion 32 for preventing the rotation due to impact in the Z axis direction and lower protruding portions 15 and 16 and upper protruding portions 22 and 23 for preventing excessive displacement in the X axis direction are provided below and above weight portion 13, resistance to impact can significantly be improved.

### Fourth Exemplary Embodiment

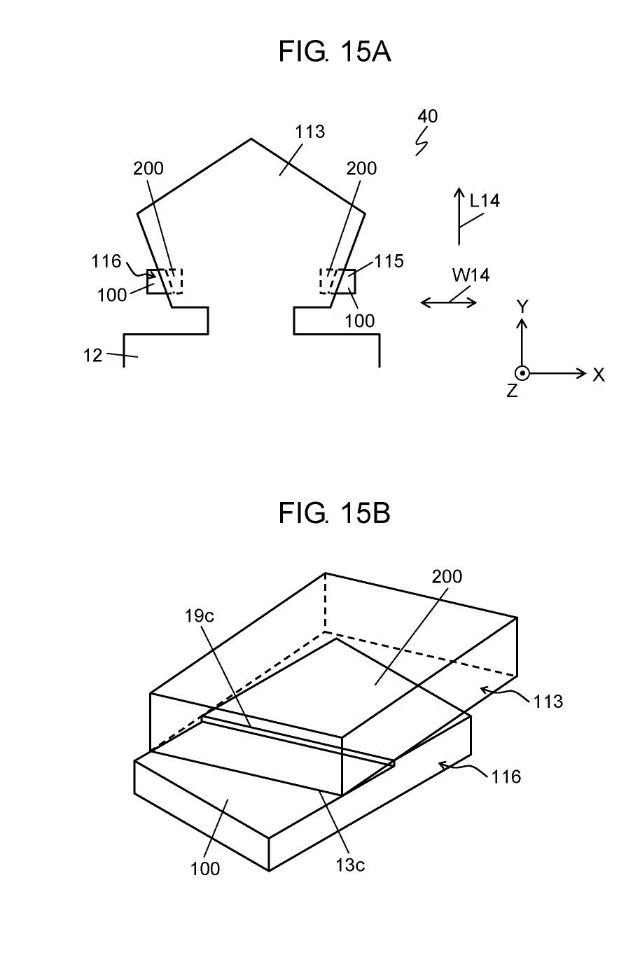

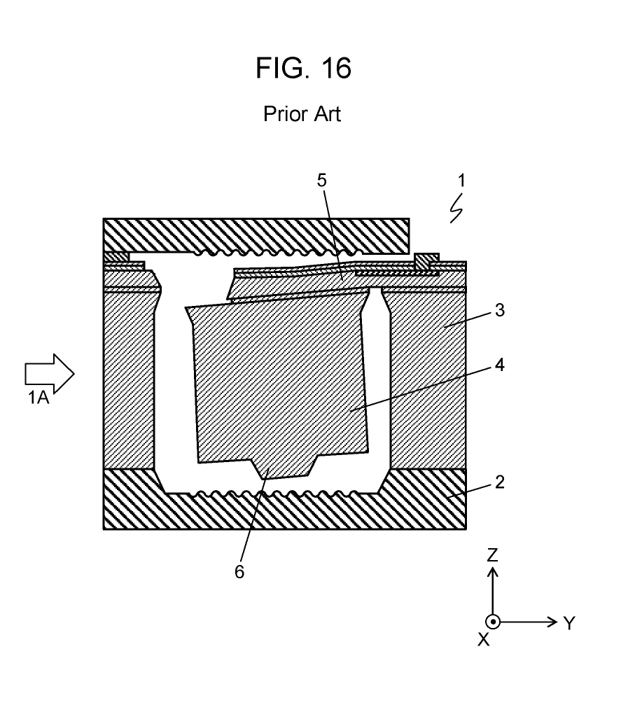

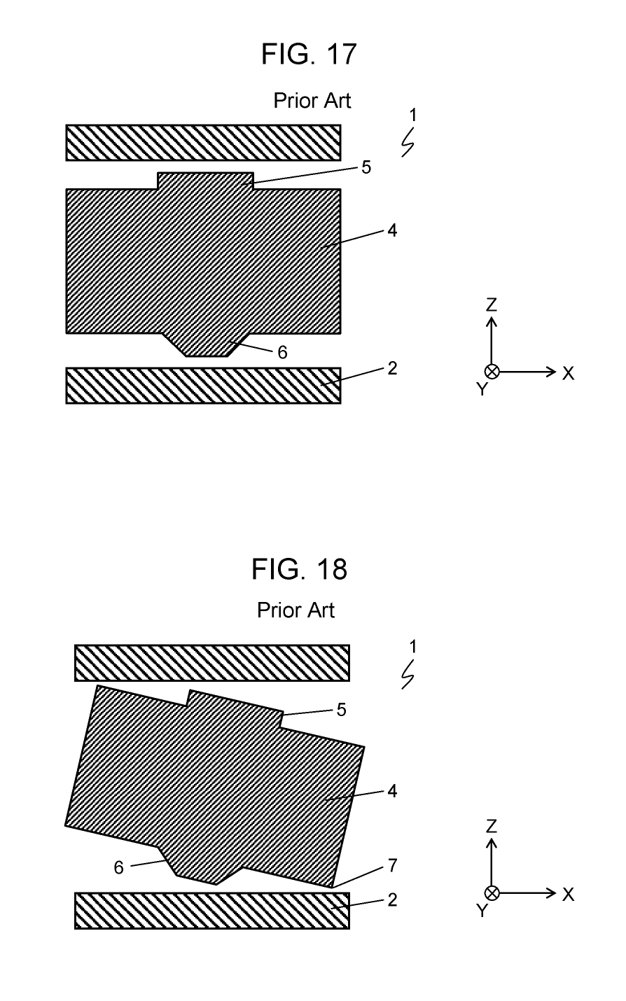

Next, a sensor according to a fourth exemplary embodiment will be described with reference to FIGS. 15A and 15B. FIG. 15A is a top view of sensor 40 according to the fourth exemplary embodiment. FIG. 15B is a schematic view for describing the operation of sensor 40 according to the fourth exemplary embodiment. Note that the components same as those in the first exemplary embodiment are denoted by the same reference marks, and the description thereof will be omitted.

Sensor 40 in the fourth exemplary embodiment and sensor 10 in the first exemplary embodiment is different from each other in the shape of weight portion 113 and the shapes of first surfaces 100 and second surfaces 200 of lower protruding portions 115 and 116.

The other configuration is the same as that of the first exemplary embodiment, and the description thereof will be omitted.

As illustrated in FIG. 15A, weight portion 113 is not necessarily rectangular or square. In addition, the boundary line between first surface 100 and second surface 200 of each of lower protruding portions 115 and 116 is not necessarily parallel to the direction of L14 or W14.

It is to be noted that, in the second and third exemplary embodiments, the shape of weight portion 13 is not limited, as in the fourth exemplary embodiment.

While the sensor in the first to fourth exemplary embodiments is an acceleration sensor, the present invention is applicable to a variety of other sensors such as an angular velocity sensor, a strain sensor, a barometric pressure sensor, and a pressure sensor, so long as it detects a physical amount based on rotation or displacement of a weight portion.

In the above-mentioned exemplary embodiments, the terms indicating a direction, such as “upper surface”, “lower surface”, “above”, or “below”, indicate a relative direction depending on only the relative positional relation of the components of the sensor, such as the substrate or the weight portion, and does not indicate an absolute direction such as a vertical direction.

Notably, in the above-mentioned exemplary embodiments, weight portion 13 and lower protruding portion 16 are not limited to be simultaneously in contact with each other on two locations which are ridge line 13d and ridge line 19d, when they come into contact with each other, in an actual mechanism, for example. That is, there may the case where ridge line 13d contacts first, and then, ridge line 19d contacts, or where ridge line 19d contacts first, and then, ridge line 13d contacts. However, since beam portion 14 is elastically deformed, weight portion 13 and lower protruding portion 16 are brought into contact with each other on two lines (two locations) which are ridge line 13d and ridge line 19d with time. Similarly, lower protruding portions 15, 16, 31, 115, and 116 and upper protruding portions 22, 23, and 32 are consequently also brought into contact with weight portion 13 on two ridge lines due to the rotation of weight portion 13.

Note that all of the ridge lines described above are not necessarily limited to be a straight line. The ridge lines may be a slightly curved line.

### INDUSTRIAL APPLICABILITY

The sensor according to the present disclosure provides an effect such that the weight portion and the substrate hardly adhere to each other due to sticking, even if excessive acceleration is applied. Particularly, the sensor according to the present disclosure is useful as a sensor used for a vehicle, a navigation system, or a mobile terminal, such as an inertial sensor which is, for example, an acceleration sensor or an angular velocity sensor, a strain sensor, or a barometric pressure sensor.

### REFERENCE MARKS IN THE DRAWINGS

10, 24, 30, 33, 40: sensor
11: first substrate
12: support portion
13, 113: weight portion
14: beam portion
13c, 13d, 13e, 13f, 13g: ridge line
15, 16, 31, 115, 116: lower protruding portion (first protruding portion)
17: stepped part
17A: taper surface
19c, 19d, 19e, 19f, 19g: ridge line
21: second substrate
22, 23, 32: upper protruding portion (second protruding portion)
81a: upper surface
83a: upper surface
83b: lower surface
84a: one end (first end)
84b: other end (second end)
91b: lower surface
100: first surface
200: second surface
300: third surface
400: fourth surface

1. A sensor comprising:
a first substrate;
a first protruding portion provided on an upper surface of the first substrate;
a support portion provided on the upper surface of the first substrate;
a beam portion supported at a first end of the beam portion by the support portion; and
a weight portion provided to a second end of the beam portion,
wherein an upper surface of the first protruding portion has a first surface and a second surface, and
the second surface is located above the first surface with the upper surface of the first substrate as a reference.

2. The sensor according to claim 1, wherein, when the weight portion is rotated, the weight portion comes into line contact with the first surface, and comes into line contact with an end of the second surface.

3. The sensor according to claim 1, wherein
the first surface is disposed to extend from a region outside of a peripheral edge of the weight portion to a region inside of the peripheral edge of the weight portion in a planar view, and
the second surface is disposed in the region inside of the peripheral edge of the weight portion in a planar view.

4. The sensor according to claim 1, wherein the first surface and the second surface are connected to each other by a taper surface.

5. The sensor according to claim 4, wherein the taper surface has a plurality of irregularities.

6. The sensor according to claim 1, further comprising:
a second substrate provided to an upper part of the support portion and extending from the support portion; and
a second protruding portion provided on a lower surface of the second substrate,
wherein the first substrate and the second substrate are disposed to be parallel to each other,
a lower surface of the second protruding portion has a third surface and a fourth surface, and
the fourth surface is located below the third surface with the lower surface of the second substrate as a reference.

7. The sensor according to claim 6, wherein, when the weight portion is rotated, the weight portion comes into line contact with the third surface, and comes into line contact with an end of the fourth surface.

8. The sensor according to claim 6, wherein
the third surface is disposed to extend from a region outside of a peripheral edge of the weight portion to a region inside of the peripheral edge of the weight portion in a planar view, and
the fourth surface is disposed in the region inside of the peripheral edge of the weight portion in a planar view.
